(19) United States
(12) Patent Application Publication
(10) Pub. No.: US 2007/0152459 A1
(43) Pub. Date: Jul. 5, 2007

(54) Contact lens picker

(75) Inventors: Travis M. Fisher, Webster, NY (US); Thomas F. Natalie, Rochester, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/593,254

(22) Filed: Nov. 6, 2006

Related U.S. Application Data
(60) Provisional application No. 60/766,011, filed on Dec. 29, 2005.

(51) Int. Cl. B25J 15/08

(52) U.S. Cl. 294/103.1

(57) ABSTRACT

A contact lens picker has a linear variable differential transformer (LVDT) operably coupled to a pair of arms, the arms moveable between a release position and a picking position. A controller coupled to the LVDT compares an output of LVDT at successive picking positions to determine whether a contact lens has been picked up.

### FIELD OF THE INVENTION

This invention relates generally to an apparatus for transporting optical parts such as contact lenses and more particularly to an apparatus for picking up contact lenses of varying thickness and reliably determining whether a lens has been successfully picked up.

### DESCRIPTION OF RELATED ART

In the automatic manufacture and packaging of contact lenses, it is necessary, at various stages of the manufacturing, to pick up a contact lens and move it to another location. For example, during manufacture, individual, wet, contact lenses may be moved from their respective trays into an inspection cell. While devices for reliably picking up contact lenses are known, contact lenses may be quite thin and the thickness may vary from one lens to another and therefore, it may be difficult to reliably determine that a contact lens has been successfully picked up by the picking apparatus. There is a need for an apparatus that can reliably sense when a contact lens has been picked up, including contact lenses of different thicknesses.

### BRIEF SUMMARY OF THE INVENTION

Briefly stated, the present invention contemplates a lens picker for picking up a contact lens, the lens picker including first and second relatively movable arms, a driver coupled to at least one of the arms, a linear variable differential transformer coupled between the arms, and a controller coupled to the driver and the linear variable differential transformer for sequentially moving the arms between a first release position and a second picking position and comparing the output of the linear variable differential transformer at successive picking positions to determine whether a contact lens has been picked up.

### BRIEF DESCRIPTION OF THE SEVERAL VIEWS OF THE DRAWING(S)

FIG. 1 is a perspective view in diagrammatic form of a lens picker of the present invention.

FIG. 2 is a top plan view of the lens picker of FIG. 1.

FIG. 3 is a left side elevation of the lens picker of FIG. 1.

FIG. 4 is a graphical representation of the average and minimum difference values of the linear variable differential transformer between a successful and an unsuccessful pickup for various spherical and toric contact lenses.

FIG. 5 is a graphical representation of the output of the linear variable differential transformer of this invention for a series of 50 pickups of a first toric contact lens.

FIG. 6 is a graphical representation of the output of the linear variable differential transformer of this invention for a series of 50 pickups of a second toric contact lens.

FIG. 7 is a graphical representation of the output of the linear variable differential transformer of this invention for a series of 250 pickups of a series of different toric lenses.

### DETAILED DESCRIPTION OF THE INVENTION

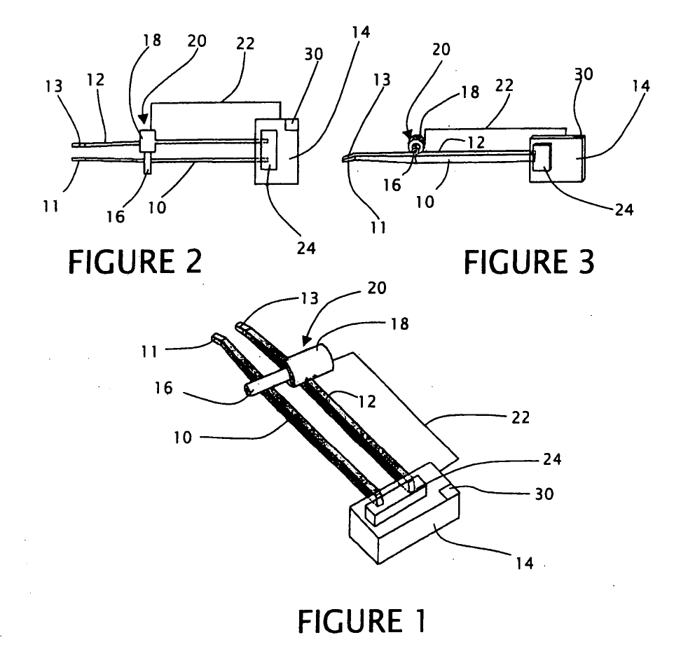

Referring to FIG. 1, a lens picker 8 in accordance with the present invention is illustrated in diagrammatic form. Preferably, the lens picker 8 forms a portion of a robotic arm (not shown) implemented to transfer individual wet contact lenses (not shown), for example from a respective tray into an inspection cell. It is understood the lens picker 8 can be used with robotic arms and actuators of various sorts. The details of the robotic arm and an actuator for the robotic arm are well known to those skilled in the art and will not be described in detail here.

As seen in FIG. 1, the lens picker 8 includes first and second relatively movable arms 10, 12. A controller 14 includes a driver 24 coupled to at least one and in certain configurations to both of the arms 10, 12 for moving the ends of the arms together to pick up a lens. Preferably, the arms 10, 12 are made from stainless steel and more preferably are stainless steel forceps covered with silicone, such as a silicone tubing 11, 13 respectively so as not to contaminate or damage the contact lenses. While other materials may be used for the arms 10, 12, the materials, and hence arms should be nonmagnetic so as not to interfere with the magnetic properties of the lens picker 8, and particularly a linear variable differential transformer, as employed in the lens picker 8.

The driver 24 operating the arms 10, 12 can be a hydraulic or a pneumatic device of a type known to those of ordinary skill in the art. A preferred configuration of the driver 24 includes a pneumatic clamp capable of moving one or both arms 10, 12 together to pick up a lens. In one configuration, one arm is stationary and the other arm is moved so as to maximize the accuracy of the operation. For purposes of description only, and without limiting the scope of the invention, arm 10 is set forth as a moveable arm and arm 12 is a stationary arm.

A linear variable differential transformer (LVDT) 20 is coupled to the arms 10 and 12. In one configuration, the LVDT 20 is connected to the arms 10, 12 by a shock and vibration reducing mount. Such mounts include resilient elastomeric thermoplastic, thermoplastic elastomer or thermoplastic vulcanizate materials, preferably being nonconductive (insulative).

The LVDT 20 is a well known construction to those in the art. The LVDT 20 includes a core 16 and a coil 18, wherein in one configuration, the core 16 is coupled to movable arm 10 and the coil 18 is coupled to the stationary arm 12. Preferably, the core 16 and the coil 18 are firmly mounted to respective arms 10 and 12 in a manner that reduces or eliminates any vibration or movement of the core within the coil assembly except when the picker 8 is opening or closing. Furthermore, LVDT 20 is preferably mounted relatively close to the ends of the arms 10, 12 so as to maximize the accuracy of the reading by or signal from the LVDT. That is, the throw of the core 16 relative to the coil 18 is maximized, thereby maximizing the resulting signal.

The LVDT 20 is connected to the controller 14 by a cable 22. The controller 14 preferably includes a signal conditioner such as an LVC 2402 or LVC 2412 signal conditioner manufactured by Macro Sensors division of Howard A. Schaevitz Technologies Inc. of Pennsauken, N.J. The signal conditioner is responsive to the output of the LVDT 20 to provide a signal for operating the driver 24 coupled to the arms 10, 12. However, it is understood that wireless communication can be provided.

Other known methods of signal conditioning such as using operational amplifier to produce only a difference voltage thereby reducing the effect of noise can be employed where desired.

The controller 14 can be any of a variety of devices known in the art, such processors, integrated circuits or chips which can be dedicated or part of an associated computer. It is also contemplated that an amplifier can be operably connected between the controller 14 and the LVDT 20.

Preferably, the LVDT 20 and the signal conditioner are mounted in an area where there is very little change in temperature. Temperature fluctuations have been found to affect the output voltage of the LVDT 20. While this invention relies not on absolute output voltages but upon the difference in output voltage between a known condition in which no lens is picked and a condition in which a lens may be picked, it is nonetheless desirable to minimize changes in temperature to maximize the accuracy of the lens picking determination.

While the invention is particularly addressed to apparatus for transferring wet contact lenses from their respective trays into an inspection cell during manufacturing, the lens picker 8 can also be used at other stages of contact lens manufacturing where it is important to accurately determine whether a contact lens has been picked up or not.

It is required to know with great accuracy when a lens has been successfully picked up and when it has not. An important aspect of apparatus for picking up wet contact lenses during manufacturing is to apply a low force to the contact lens so as not to damage the lens. Accordingly, in accordance with this invention, the sensor, such as the LVDT 20, coupled to the arms 10, 12 must add little or no friction or resistance to the movement of the arms. It is also advantageous that the sensor, such as the LVDT 20, be relatively small and add a relatively small amount of mass to the arms 10, 12. It has been found that the LVDT 20 coupled between the arms 10, 12 of the lens picker 8 satisfies these requirements.

An advantage of the LVDT 20 is the mechanical friction-free operation. In normal use, there is no mechanical contact between the core 16 and coil 18, so there is no rubbing, dragging or other source of mechanical friction. This is especially important in high reliability applications such as contact lens manufacture.

Soft contact lenses are quite thin. The center thickness may be as low as 30 μm. The thickness of the lens at the edge is somewhat greater. The thickness of a soft contact lens will vary with the optical power of the lens. The lens picker 8 must be capable of determining whether a lens has been picked up or not over a range of thicknesses of lenses. Because the lenses are so thin, the resolution of a sensor, such as the LVDT 20, used to determine whether a lens has been successfully picked up must be high.

Since the LVDT 20 operates on electromagnetic coupling principles in a friction-free structure, the LVDT can measure infinitesimally small changes in the position of the core 16. This infinite resolution capability is limited only by the noise in an LVDT signal conditioner and the resolution of an output display. These same factors also give an LVDT outstanding repeatability.

Contact lenses, especially soft contact lenses, are frequently made in a large-scale manufacturing environment. Accordingly, the lens picker 8 for use in a contact lens manufacturing operation must be reliable over a large number of operations. In order to provide reliable trouble-free operation over a large number of lens pickups, it is important the lens picker 8 be tolerant of at least slight misalignments and be able to continue to provide reliable indications without recalibration over a large number of cycles.

The LVDT 20 responds to motion of the core 16 along the axis of the coil 18, but is generally insensitive to cross-axis motion of the core or to the radial position of the core. Thus, an LVDT can usually function without adverse effect in applications involving misaligned or floating moving members, and in cases where the core does not travel in a precisely straight line.

Because the manufacture of soft contact lenses may take place in an environment that is potentially detrimental to the machines and sensors used in manufacture, it is important that the lens picker 8 be resistant to relatively harsh environments. The materials and construction techniques used in assembling an LVDT result in a rugged, durable sensor that is robust to a variety of environmental conditions. Bonding of the windings is followed by epoxy encapsulation into a case, resulting in superior moisture and humidity resistance. Both the case and the core 16 are made of corrosion resistant metals, with the case also acting as a supplemental magnetic shield. The internal high-permeability magnetic shield minimizes the effects of external AC fields that may be created either by the controller or by other apparatus used in the contact lens manufacturing operation.

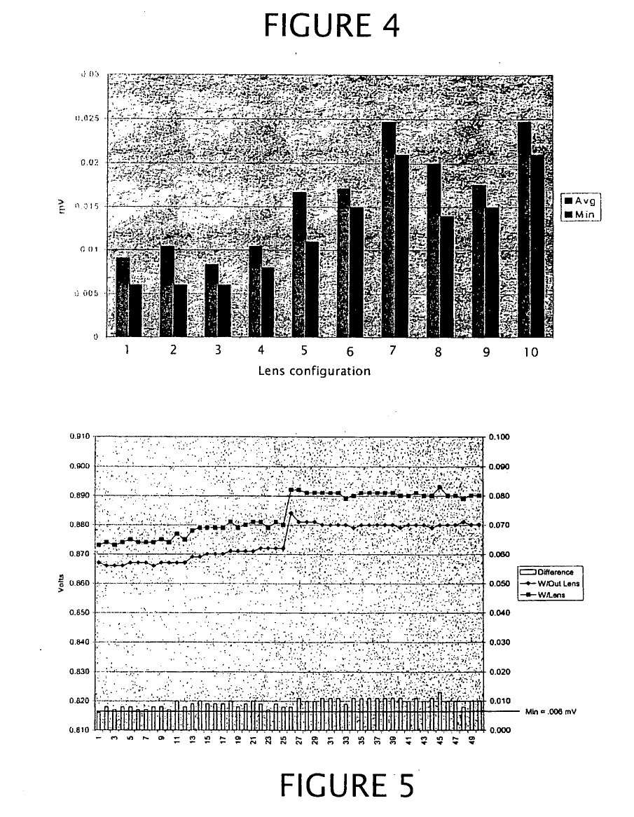

FIGS. 4-7 show the experimental results of tests made using the lens picker 8. To determine whether a lens had been successfully picked up by the lens picker 8, two voltage readings were taken, one with the lens picker closed without a lens and one with the lens picker closed with a lens. It was the purpose of the testing to verify that the difference between these two voltages is consistently large enough so that there are no discrepancies in the determination of whether or not the lens picker 8 has successfully picked up a lens. As shown in the following graphs, the smallest difference in voltage reading with and without a lens was 0.006 mV. The experimental results have confirmed that this minimum difference is consistently large enough to accurately determine that the lens picker 8 has successfully picked up a lens between the tips of the arms 10, 12.

The lenses used in the test had been through the full manufacturing process including sterilization and labeling. The lenses were sealed in blister packs and fully hydrated prior to the testing. In each test, the lens picker 8 was first closed without a lens being present and a voltage reading was taken. The lens picker 8 was then opened, a lens edge was placed in the picker grasp area and the picker was closed. Another voltage reading was taken. In each of the tests illustrated in FIGS. 4-6, this test cycle was repeated 25 times as quickly as possible using the same lens and making sure that the pickers grabbed the lens in the same area each time. The target cycle time was four seconds. Because the thickness of a toric lens varies depending on radial location, the test toric lenses were picked up in a thinner part of the lens so that the data gathered was a minimum difference value or worst-case scenario. This demonstrated that the lens picker 8 quickly produced a discernible output voltage so that the success of the picking operation could be measured and then quickly opened for the next cycle.

FIG. 4 is a summary of the average and minimum difference values for 25 operations on 10 different lenses. It can be seen that in the worst case, the minimum difference was approximately 0.006 mV and the average difference was approximately 0.009 mV.

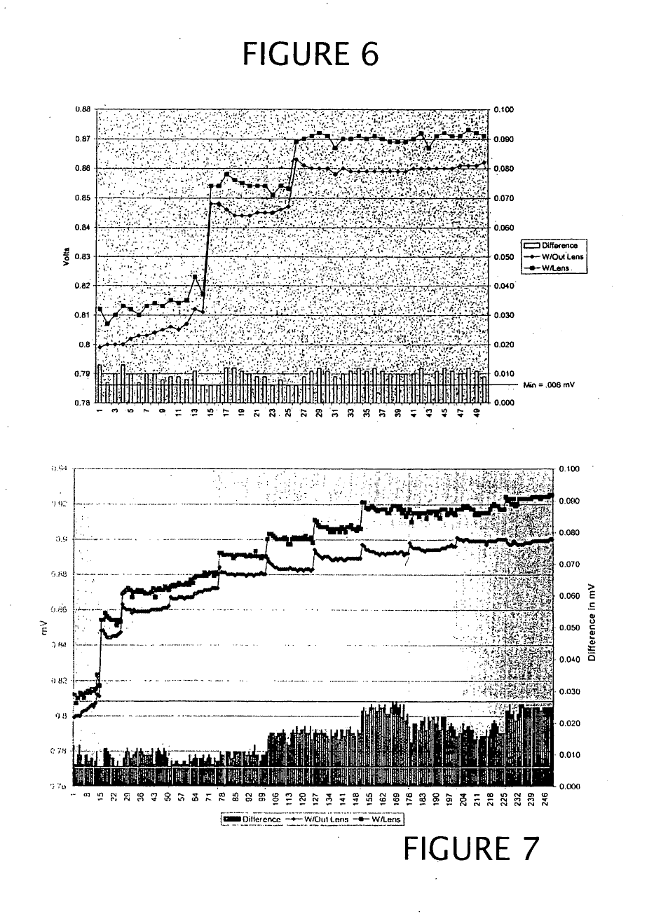

FIGS. 5 and 6 show the results of tests on minus 1.25 power and minus 3.00 power toric lenses, respectively. In each test, the same lens was picked 50 times in succession. In FIG. 6, two discontinuities are observed. In each of these, the operator dropped the lens during testing and quickly rinsed and rehydrated the lens and continued with the test. The increase in voltage associated with these jobs is due to an increase in temperature of the LVDT 20. The bar graph at the bottom of FIGS. 5 and 6 shows a voltage difference between the successive no lens and lens pickup measurements. As can be seen, the difference is consistently greater than 0.006 mV. The increase in absolute voltage observed on these graphs is due to the heating of the LVDT 20 during the test. It can be observed however that even after a significant increase in the absolute voltage due to heating, the difference remains greater than 0.006 mV.

FIG. 5 shows the results of 50 successive pickups of a 1.25 power toric lens. It can be seen from FIGS. 5 and 6 that once the temperature stabilizes, the output voltages for no lens and a successful lens pickup remained relatively constant and the difference is consistently greater than 0.006 mV.

FIG. 7 is a graphical representation of the data obtained during 250 pickup cycles of 10 different lenses. This is the raw data used to provide the average and minimum difference values shown in FIG. 4. Every 25 consecutive points represents a new lens test. FIG. 7 clearly illustrates the logarithmic warm-up time ramp of the lens picker 8. Reference to FIG. 7 reveals two phenomena. First, the LVDT coil 18 produces a higher absolute output voltage as it warms up. Second, at the beginning of each new step, the output voltage decreases for the first few cycles and then levels out. This is also due to the warming of the LVDT coil 18. When the coil 18 is powered up, that is when voltage is applied to it, and the core 16 is extended, that is it is outside the coil, the coil generates heat which in turn creates a greater voltage. When the arms 10, 12 are closed and the core 16 is inside the coil 18, the coil stops generating heat and eventually cools down. Thus, when the tests are actually being carried out and the core 16 is repeatedly positioned in the coil 18, the temperature of the coil is reduced. The overall increase in temperature was created because during the test, when no lens was being picked, the arms 10, 12 were left in the open position with the core 16 entirely outside of the coil 18, thus maximizing the heating. It will be appreciated that when the lens picker 8 is actually being used, and lenses are repeatedly being picked up and transferred, the coil temperature will stabilize thus providing accurate readings.

Therefore, one configuration of the controller 14 encompasses a temperature compensation. The temperature compensation can be an algorithmic compensation based on a sensed temperature. Alternatively, a local temperature control such as a heater or cooler can be thermally coupled to the controller 14 and/or LVDT 20. Thus, it is contemplated the controller 14 can cooperate with a temperature sensor 30 or local heating/cooling element (not shown).

While the invention has been described in connection with a presently preferred embodiment thereof, those skilled in the art will recognize that certain modifications and changes may suggest themselves to one skilled in the art. The following claims are intended to encompass those and other changes within the true spirit and scope of the invention.

What is claimed is:

1. A lens picker for picking up a contact lens comprising:
first and second relatively movable arms;
a driver coupled to at least one of the arms;
a linear variable differential transformer (LVDT) coupled between the arms; and
a controller coupled to the arms for sequentially moving the arms between a first release position and a second picking position and comparing an output of the LVDT at successive picking positions to determine whether a contact lens has been picked up.

2. The lens picker of claim 1 in which the controller compares an LVDT output voltage produced at successive picking positions.

3. The lens picker of claim 2 in which the controller causes the arms to be brought to a picking position without a lens present prior to each attempt to pick an actual lens.

4. The lens picker of claim 1 in which the LVDT comprises a coil connected to one arm and a core connected to the other arm.

5. The lens picker of claim 1 in which the controller compares the LVDT output to a threshold.

6. The lens picker of claim 5, wherein the controller compares an LVDT output voltage to a threshold voltage.

7. The lens picker of claim 1 in which the controller comprises an amplifier connected to the LVDT.

8. The lens picker of claim 1 in which the LVDT is mounted to the arms by a shock and vibration reducing mount.

9. The lens picker of claim 1 in which the controller is temperature compensated.

10. A method of picking up a contact lens comprising the steps of:
providing a pair of pick up arms movable between an open position and a pick up position;
coupling a linear variable differential transformer (LVDT) between the arms;
moving the arms to the pickup position with no contact lens disposed between the arms and observing the voltage of the LVDT; and
moving the arms to the pickup position and determining whether a contact lens is present by comparing the output voltage of the LVDT to the observed voltage.

11. The method of claim 10 in which said coupling step comprises coupling a core of the LVDT to one of said pair of arms and coupling the coil of an LVDT to the other of said pair of arms.
